(19) United States
(12) Patent Application Publication
(10) Pub. No.: US 2011/0198458 A1
(43) Pub. Date: Aug. 18, 2011

(54) TAMPER RESISTANT GLIDE

(75) Inventors: Scott Karl, Geneva, IL (US); Peter Graves, Palos Park, IL (US); Brian Moon, Sycamore, IL (US)

(73) Assignee: THE NORIX GROUP, West Chicago, IL (US)

(21) Appl. No.: 12/688,626

(22) Filed: Jan. 15, 2010

Related U.S. Application Data
(60) Provisional application No. 61/205,241, filed on Jan. 15, 2009.

(51) Int. Cl. A47B 91/06; B60B 33/00; B23P 11/00

(52) U.S. Cl. 248/188.4; 248/188.9; 29/428

(57) ABSTRACT

A tamper resistant adjustable glide assembly for furniture is disclosed that comprises a foot, a stem and an insert connected to a leg of the furniture. The foot having a having a top and a bottom, the bottom adapted to engage a floor surface. A stem mount on the top of the foot to provide an adjustable attachment to a first end of the stem. The stem having a second end spaced from the top of the foot and a threaded portion intermediate the first end and the second end. An insert captured on the stem. The insert threadably engaged to the stem by a generally cylindrical body with a threaded passage extending through the body adapted to matingly engage the threaded portion of the stem. A cap fixed on the second end of the stem to capture the insert. The insert disposed in a generally vertical passageway formed in the furniture and fixed therein to secure the glide assembly to the leg. The insert recessed into the leg to prevent prying or forcible removal without destruction of the furniture.

### FIELD OF THE INVENTION

The present invention relates to floor engaging furniture glides permanently attached to furniture to allow horizontal adjustment of a foot supporting the furniture to accommodate an uneven floor.

### BACKGROUND

A tamper resistant glide is a foot device attached to a piece of furniture such as a table, chair or couch to contact the floor. The prior art discloses glides having a means for adjusting the position of a foot to accommodate an uneven floor or to adjust the height of the furniture. The prior art glides may also have a foot adjustably attached to the furniture by a means for mounting on the furniture to allow rotational, vertical and angular adjustment of the foot with respect to the furniture. The prior art adjustable glide is attached on each leg of a table for example, to allow the legs to be independently adjusted to accommodate uneven floors to hold the table in a desired position.

The prior art further discloses a glide that may have a foot comprising a top attached to the furniture and a bottom surface engaging the floor to help slide furniture to a new location. Conversely, the foot may have a bottom surface to increase friction with the floor, provide a larger footprint to distribute the weight on the floor under the glide or may have an alternate floor-engaging surface.

The prior art glide prior art discloses a vertical, threading translational adjustment to allow movement of the glide with respect to the furniture. The threadable engagement may be used to allow a vertically oriented, threaded stem to be turned with respect to the furniture to allow the foot to translate vertically. The adjustable glide assembly may be unscrewed or pried off the furniture and removed.

Prior art glide assemblies do not secure the glide assembly to the furniture, to prevent tampering. Removal may cause the table to need repair or replaced. Furthermore, the removed glide may be used for improper purposes in some environments. It is desirable to secure to the glide in the furniture to prevent removal by intentional or unintentional means. There is a need to provide a tamper resistant glide that conceals the mounting means to provide secure attachment of the glide in the furniture. In an environment such as a correctional facility, devices such as a glide assembly must be secured to the furniture to prevent such removal and abuse such as the using the glide to form a weapon or tool. Generally, users of the furniture in these facilities will not have tools to use. It is further desirable to provide a glide that is tamper resistant to prevent removal without tools.

### SUMMARY OF ONE EMBODIMENT OF THE INVENTION

### ADVANTAGES OF ONE OR MORE EMBODIMENTS OF THE PRESENT INVENTION

The various embodiments of the present invention may, but do not necessarily, achieve one or more of the following advantages:

the ability to prevent tampering by a secure assembly wherein the stem on the foot is captured in an insert that may be fixed in the furniture support;

the ability to secure the insert on the stem intermediate a glide foot on a first end of the stem and an insert retainer on a second end of the stem;

the ability to secure the insert in the furniture support by recessed mounting;

the ability to fix the insert in the furniture support spaced from an outside surface to prevent prying the insert off

provide a secure fixation of the glide in the furniture support;

provide a secure capture of the stem in the insert; and

provide a tamper resistant adjustable glide in the furniture.

These and other advantages may be realized by reference to the remaining portions of the specification, claims, and abstract.

The above description sets forth, rather broadly, the more important features of the present invention so that the detailed description of the preferred embodiment that follows may be better understood and contributions of the present invention to the art may be better appreciated. There are, of course, additional features of the invention that will be described below and will form the subject matter of claims. In this respect, before explaining at least one preferred embodiment of the invention in detail, it is to be understood that the invention is not limited in its application to the details of the construction and to the arrangement of the components set forth in the following description or as illustrated in the drawings. The invention is capable of other embodiments and of being practiced and carried out in various ways. Also, it is to be understood that the phraseology and terminology employed herein are for the purpose of description and should not be regarded as limiting.

### BRIEF DESCRIPTION OF ONE EMBODIMENT OF THE PRESENT INVENTION

A tamper resistant glide mounted in a piece of furniture for supporting an object off a floor having a furniture support engaging the floor. The furniture support may be a chair end, leg, pedestal or such. The glide may comprise a foot, a stem and an insert. The foot having a having a top and a bottom, the bottom adapted to engage a floor surface. A stem mount on the top of the foot to provide an attachment to a first end of the stem. The stem having a second end spaced from the top of the foot and a threaded portion intermediate the first end and the second end. The threaded portion engaging an insert having a generally cylindrical body with a stem passage extending through the insert body. Threads in the stem passage may be adapted to matingly engage the threaded portion of the stem to allow translation of the insert along the stem when the stem is rotated with respect to the insert. The stem may be threaded into and extending through the insert such that the insert is intermediate the first end and the second end.

An insert retainer may be disposed adjacent the second end of the stem. The insert retainer may be adapted to capture the insert on the stem to prevent removal. The insert retainer may further prevent the stem from threading out of the stem passage by interfering with the threaded interface between the stem and the insert. The furniture support having a generally vertical portion such as a leg having a floor end on the lower portion. A vertical passage is formed in the furniture support. The vertical passage having a length longer than a length of the stem and a diameter sufficient to accept and retain the insert. The insert may be mounted in the furniture support such that the stem passage is generally vertical and the floor end is intermediate the insert and the foot.

The above description sets forth, rather broadly, a summary of one embodiment of the present invention so that the detailed description that follows may be better understood and contributions of the present invention to the art may be better appreciated. Some of the embodiments of the present invention may not include all of the features or characteristics listed in the above summary. There are, of course, additional features of the invention that will be described below and will form the subject matter of claims. In this respect, before explaining at least one preferred embodiment of the invention in detail, it is to be understood that the invention is not limited in its application to the details of the construction and to the arrangement of the components set forth in the following description or as illustrated in the drawings. The invention is capable of other embodiments and of being practiced and carried out in various ways. Also, it is to be understood that the phraseology and terminology employed herein are for the purpose of description and should not be regarded as limiting.

### BRIEF DESCRIPTION OF THE DRAWINGS

FIG. 1 is substantially an exploded view of a chair having one embodiment of the tamper resistant glide of the present invention.

FIG. 2 is substantially an elevation view of a first embodiment of the tamper resistant glide of the present invention.

FIG. 3 is substantially a perspective view of a cap of the present invention.

FIG. 4 is substantially a perspective view of a second embodiment of the insert with a cutaway showing the threaded passage.

FIG. 5 is substantially an elevation view of the tamper resistant glide mounted in a furniture leg with a cutaway.

FIG. 6 is substantially a section bottom view of the chair of FIG. 1 taken at approximately 1-1 of FIG. 1.

FIG. 7 is substantially a perspective view of a first embodiment of a first alternate furniture piece of FIG. 6 incorporating the present invention.

FIG. 8 is substantially a back elevation view of the first embodiment of the first alternate furniture piece incorporating the present invention.

FIG. 9 is substantially a top view of the first embodiment of the first alternate furniture piece incorporating the present invention.

FIG. 10 is substantially a side elevation view of the first embodiment of the first alternate furniture piece incorporating the present invention.

FIG. 11 is substantially a front elevation view of the first embodiment of the first alternate furniture piece incorporating the present invention.

FIG. 12 is substantially a bottom view of a second the first embodiment of the first alternate furniture piece incorporating the present invention.

FIG. 13 is substantially a perspective view of a the second embodiment of the first alternate furniture piece incorporating the present invention.

FIG. 14 is substantially a back elevation view of the second embodiment of the first alternate furniture piece incorporating the present invention.

FIG. 15 is substantially a top view of the second embodiment of the first alternate furniture incorporating the present invention.

FIG. 16 is substantially a side elevation view of the second embodiment of the first alternate furniture incorporating the present invention.

FIG. 17 is substantially a front elevation view of the second embodiment of the first alternate furniture incorporating the present invention.

FIG. 18 is substantially a bottom view of the second a third embodiment of the first alternate furniture piece incorporating the present invention.

FIG. 19 is substantially a perspective view of a the third embodiment of the first alternate furniture piece incorporating the present invention.

FIG. 20 is substantially a back elevation view of the third embodiment of the first alternate furniture piece incorporating the present invention.

FIG. 21 is substantially a top view of the third embodiment of the first alternate furniture piece incorporating the present invention.

FIG. 22 is substantially a side elevation view of the third embodiment of the first alternate furniture piece incorporating the present invention.

FIG. 23 is substantially a front elevation view of the third embodiment of the first alternate furniture piece incorporating the present invention.

FIG. 24 is substantially a bottom view of the third a fourth embodiment of the first alternate furniture piece incorporating the present invention.

FIG. 25 is substantially a perspective view of a the fourth embodiment of the first alternate furniture piece incorporating the present invention.

FIG. 26 is substantially a back elevation view of the fourth embodiment of the first alternate furniture piece incorporating the present invention.

FIG. 27 is substantially a top view of the fourth embodiment of the first alternate furniture piece incorporating the present invention.

FIG. 28 is substantially a side elevation view of the fourth embodiment of the first alternate furniture piece incorporating the present invention.

FIG. 29 is substantially a front elevation view of the fourth embodiment of the first alternate furniture piece incorporating the present invention.

FIG. 30 is substantially a bottom view of the fourth a fifth embodiment of the first alternate furniture piece incorporating the present invention.

FIG. 31 is substantially a perspective view of a the fifth embodiment of the first alternate furniture piece incorporating the present invention.

FIG. 32 is substantially a back elevation view of the fifth embodiment of the first alternate furniture piece incorporating the present invention.

FIG. 33 is substantially a top view of the fifth embodiment of the first alternate furniture piece incorporating the present invention.

FIG. 34 is substantially a side elevation view of the fifth embodiment of the first alternate furniture piece incorporating the present invention.

FIG. 35 is substantially a front elevation view of the fifth embodiment of the first alternate furniture piece incorporating the present invention.

FIG. 36 is substantially a bottom front elevation view of the chair of FIG. 1 fifth embodiment of the first alternate furnature piece incorporating the present invention.

FIG. 37 is substantially a top view of the chair of FIG. 1 incorporating the present invention.

FIG. 38 is substantially a back elevation view of the chair of FIG. 1 incorporating the present invention.

FIG. 39 is substantially a bottom view of the chair of FIG. 1 incorporating the present invention.

FIG. 40 is substantially a perspective view of the chair of FIG. 1 incorporating the present invention.

FIG. 41 is substantially a side elevation view of the chair of FIG. 1 incorporating the present invention.

FIG. 42 is substantially a perspective view of a first embodiment of a second alternative furniture piece incorporating the present invention a front elevation view of the chair of FIG. 1 incorporating the present invention.

FIG. 43 is substantially a perspective bottom plan view of a first a second embodiment of a second alternative furniture piece incorporating the present invention.

FIG. 44 is substantially a right side elevation view of a the second embodiment of the second alternative furniture piece incorporating the present invention.

FIG. 45 is substantially a front elevation view of the second embodiment of the second alternative furniture piece incorporating the present invention.

FIG. 46 is substantially a perspective view of the second embodiment of the second alternative furniture piece incorporating the present invention.

FIG. 47 is substantially a left side elevation view of the second embodiment of the second alternative furniture piece incorporating the present invention.

FIG. 48 is substantially a top view of the second embodiment of the second alternative furniture piece incorporating the present invention.

FIG. 49 is substantially a front elevation view of the second embodiment of the second alternative furniture piece incorporating the present invention.

FIG. 50 is substantially a bottom top view of the second first embodiment of the second alternative furniture piece incorporating the present invention.

FIG. 51 is substantially a front elevation view of the first embodiment of the second alternative furniture piece incorporating the present invention.

FIG. 52 is substantially a side elevation view of the first embodiment of the second alternative furniture piece incorporating the present invention.

FIG. 53 is substantially a top back elevation view of the first embodiment of the second alternative furniture piece incorporating the present invention.

FIG. 54 is substantially a bottom view of the first embodiment of the second alternative furniture piece incorporating the present invention.

FIG. 55 is substantially a front elevation view of a third the first embodiment of the second alternative furniture piece incorporating the present invention.

FIG. 56 is substantially a side elevation bottom plan view of the a third embodiment of the second alternative furniture piece incorporating the present invention.

FIG. 57 is substantially a front elevation view of a fourth the third embodiment of the second alternative furniture piece incorporating the present invention.

FIG. 58 is substantially a perspective view of the fourth third embodiment of the second alternative furniture piece incorporating the present invention.

FIG. 59 is substantially a right side elevation view of the fourth third embodiment of the second alternative furniture piece incorporating the present invention.

FIG. 60 is substantially a back elevation view of the fourth third embodiment of the second alternative furniture piece incorporating the present invention.

FIG. 61 is substantially a left side elevation view of the fourth third embodiment of the second alternative furniture piece incorporating the present invention.

FIG. 62a is substantially a bottom top view of the fourth third embodiment of the second alternative furniture piece incorporating the present invention.

FIG. 62b 63 is substantially a top front elevation view of the a fourth embodiment of the second alternative furniture piece incorporating the present invention.

FIG. 63 64 is substantially a front elevation perspective view of a fifth the fourth embodiment of the second alternative furniture piece incorporating the present invention.

FIG. 64 is substantially a perspective view of the fifth embodiment of the second alternative furniture piece incorporating the present invention.

FIG. 65 is substantially a right side elevation view of a fifth the fourth embodiment of the second alternative furniture piece incorporating the present invention.

FIG. 66 is substantially a top view of a fifth the fourth embodiment of the second alternative furniture piece incorporating the present invention.

FIG. 67 is substantially a back elevation view of a fifth the fourth embodiment of the second alternative furniture piece incorporating the present invention.

FIG. 68 is substantially a left side elevation view of a fifth the fourth embodiment of the second alternative furniture piece incorporating the present invention.

FIG. 69 is substantially a bottom view of a fifth the fourth embodiment of the second alternative furniture piece incorporating the present invention.

FIG. 70 is substantially a front elevation view of a sixth fifth embodiment of the second alternative furniture piece incorporating the present invention.

FIG. 71 is substantially a top view of the sixth fifth embodiment of the second alternative furniture piece incorporating the present invention.

FIG. 72 is substantially a perspective view of the sixth fifth embodiment of the second alternative furniture piece incorporating the present invention.

FIG. 73 is substantially a right side elevation view of the sixth fifth embodiment of the second alternative furniture piece incorporating the present invention.

FIG. 74 is substantially a back elevation view of the sixth fifth embodiment of the second alternative furniture piece incorporating the present invention.

FIG. 75 is substantially a left side elevation view of the sixth fifth embodiment of the second alternative furniture piece incorporating the present invention.

FIG. 76 is substantially a bottom view of the sixth fifth embodiment of the second alternative furniture piece incorporating the present invention.

### DESCRIPTION OF CERTAIN EMBODIMENTS OF THE PRESENT INVENTION

In the following detailed description of the preferred embodiments, reference is made to the accompanying drawings, which form a part of this application. The drawings show, by way of illustration, specific embodiments in which the invention may be practiced. It is to be understood that other embodiments may be utilized and structural changes may be made without departing from the scope of the present invention.

The first embodiment comprises a tamper resistant, adjustable glide assembly, generally indicated by reference number 10. The tamper resistant adjustable glide assembly 10 is mounted on a furniture support 12 such as chair end 14 on chair 16.

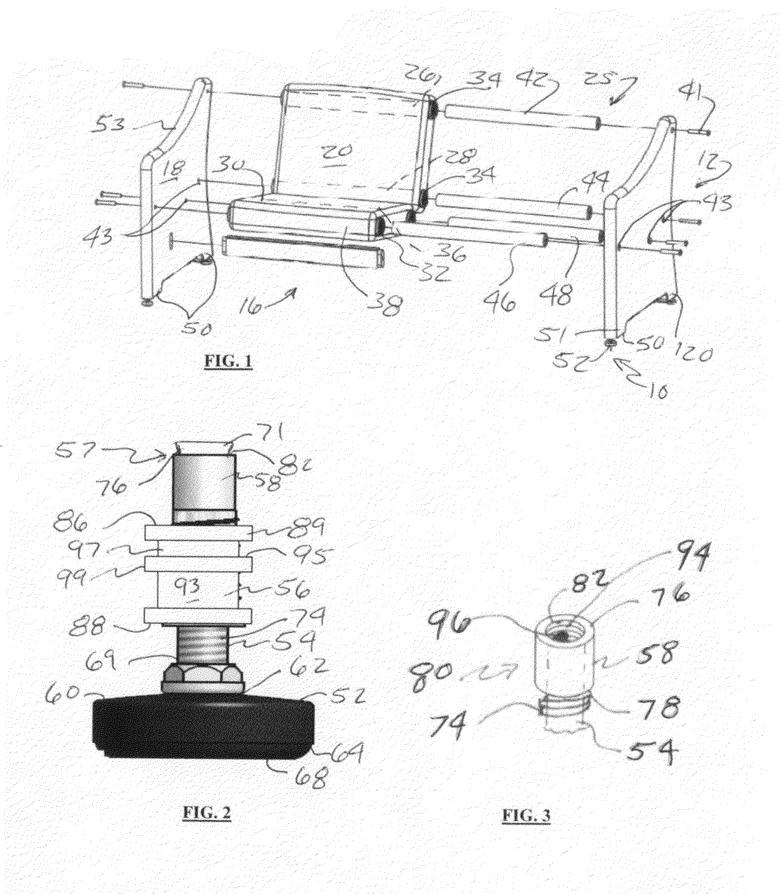

Referring to FIG. 1, Chair 16 comprises a pair of chair ends 14, 18 supporting chair back 20 and chair seat 22. The chair end 14, 18 may have a leg 120 having a floor end 50 extending downward to engage a floor 112 (FIG. 5). Chair end 14, 18 may be flat on the bottom 19 without defined legs 120 and supporting the furniture on the glide assembly 10.

Chair 16 may be a modular design having a chair back 20 and seat 22 supported between the chair ends 14, 18 by a support means 25 comprising concentrically mounted tubes. The chair ends 14, 18 may be formed of wood, plastic, metal or other material capable of supporting the chair 16. Such a supporting means 25 may further comprise support for the chair back 20 which may be integrally molded around an upper back tube 26 and lower back tube 28. Each back tube 26, 28 may likewise extend from a left side 30 to a right side 32 of the seat back 20. Each back tube 26, 28 may end at the outside of seat back 20 at grommet 34. Upper back tube 26 and lower back tube 28 form passages through the seat back 20. In a similar manner, chair seat 22 may have a rear seat tube 36 and front seat tube 38 integrally molded in the seat 22 and extending out of the seat 22 at grommet 40. Rear seat tube 36 and front seat tube 38 may extend from the left side 30 to the right side 32 to form through passages through the seat 22.

Continuing to refer to FIG. 1, support means 25 may further comprise an upper support tube 42 and lower support tube 44 extending from chair end 14 on the right, through grommets 34 and upper back tube 26 and lower back tube 28 respectively, to connect to chair end 18 on the left. The upper support tube 42 and lower support tube 44 may be attached to the chair ends 14, 16 by holes 43 in the chair end 14, 16 to receive and retain the respective end of each support tube 42, 44 and secure such with fasteners 41 extending through chair end 14,18 at fastener hole 43. Fasteners 41 may be screws, rivets or other mechanical or chemical means such as adhesive. Seat back 20 is held in a sitting position by the support tubes 42, 44 attached to chair ends 14, 16 and extending through upper and lower back tubes 26, 28 respectively.

Continuing to refer to FIG. 1, in a similar fashion, supporting means 25 may further comprise front support tube 46 and rear support tube 48 that may extend between the chair ends 14, 16 to slideably engage rear seat tube 26 and front seat tube 38 respectively to hold chair seat 22 in a sitting position. It should be understood, chair 16 may comprise more than one back 20 and seat 22 sections mounted side by side by using longer support tubes 42, 44, 46, 48 connected between chair ends 14, 16. Chair ends 14, 18 may be disposed between each adjacent pair of back 20 and seat 22 sections.

Continuing to refer to FIG. 1, an adjustable glide assembly 10 may positioned at predetermined positions of the chair 12 for example, mounted in chair end 14, 18. The adjustable glide assembly 10 is disposed in chair end 14, 18 to extend from the floor end 50 to support the chair 12 and adapt the chair to an uneven floor surface 112 (FIG. 5). Chair end 14 may have material removed along the lower floor end 50 to define a pair of legs 120 extending to engage the floor 112 (FIG. 5). Furthermore, Chair ends 14, 18 have an arm support 53 having an arcuate shape for supporting a user's arm (not shown). The arcuate shape of the chair end 14,18 is higher adjacent the upper back tube 26 and lower adjacent the front seat tube 38.

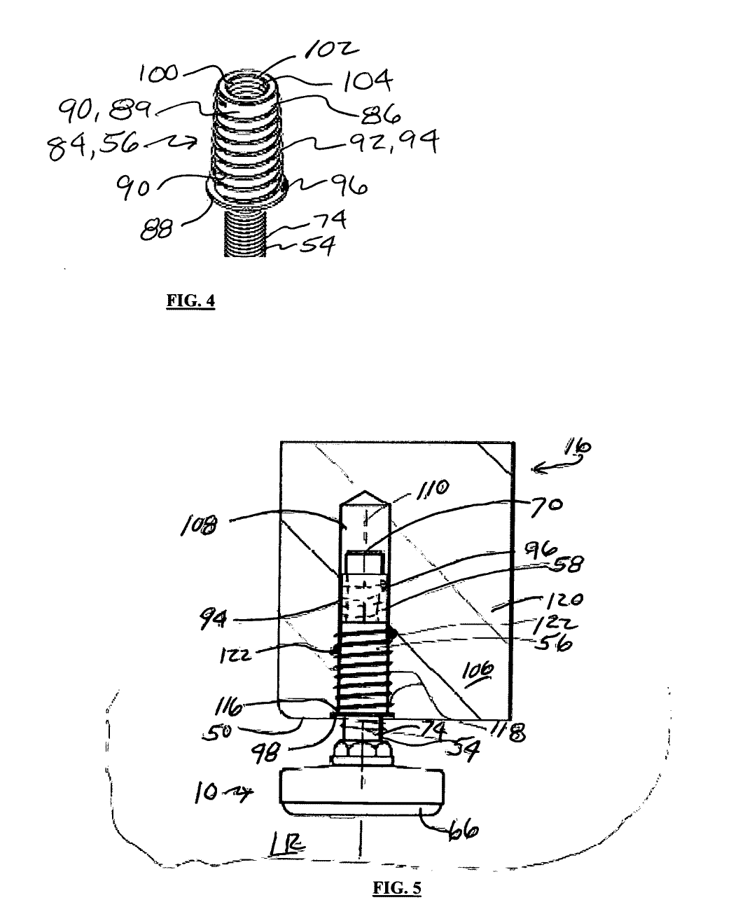

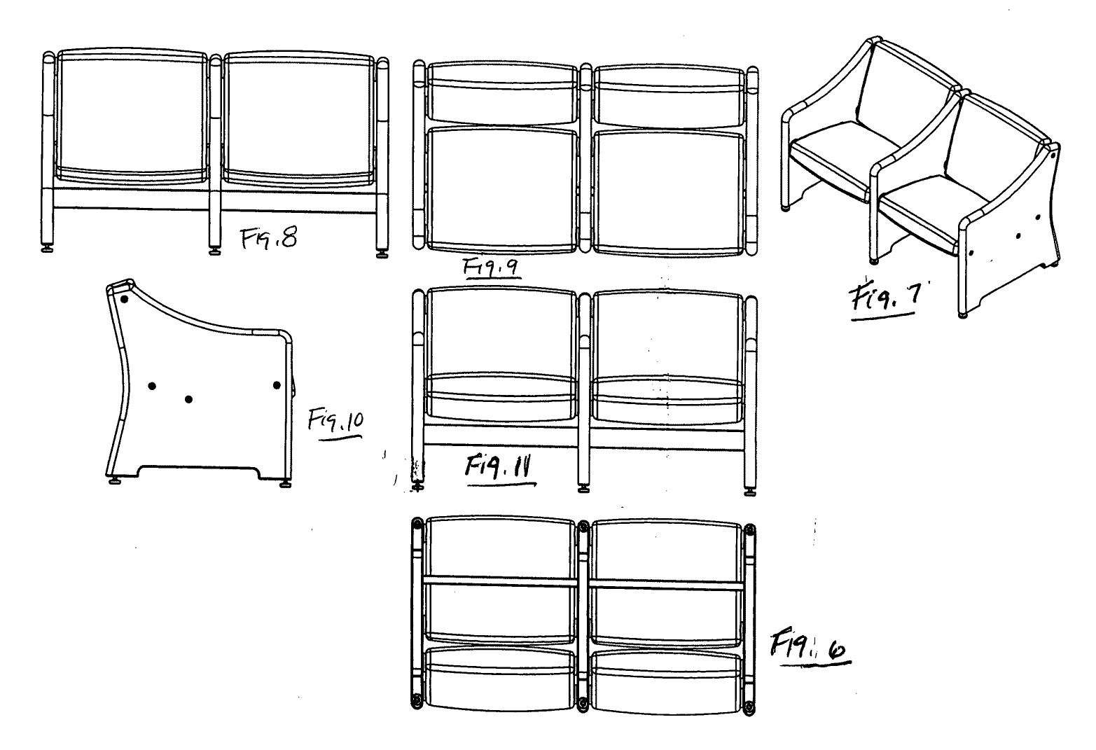

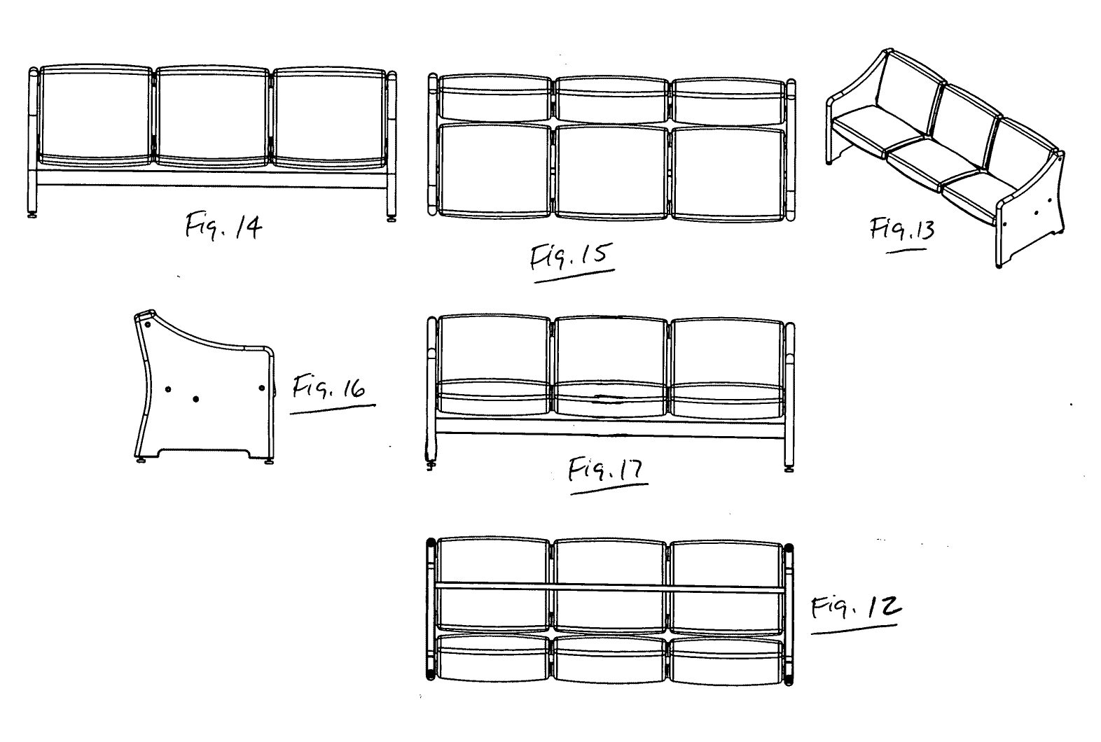

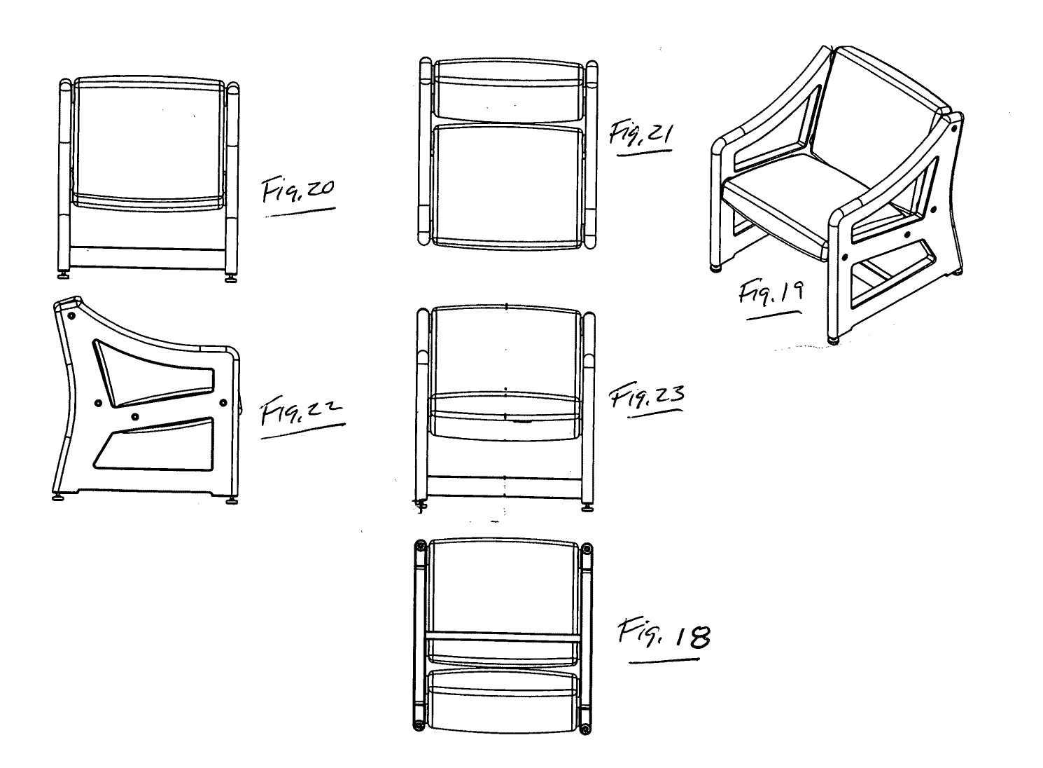

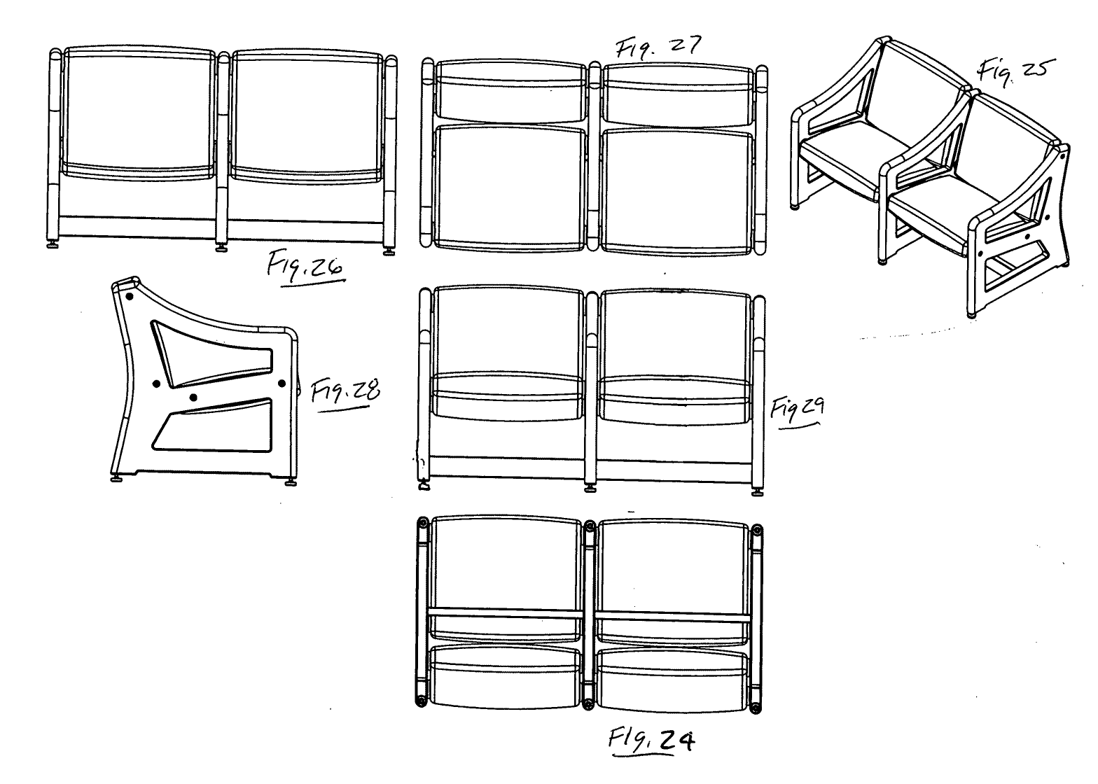

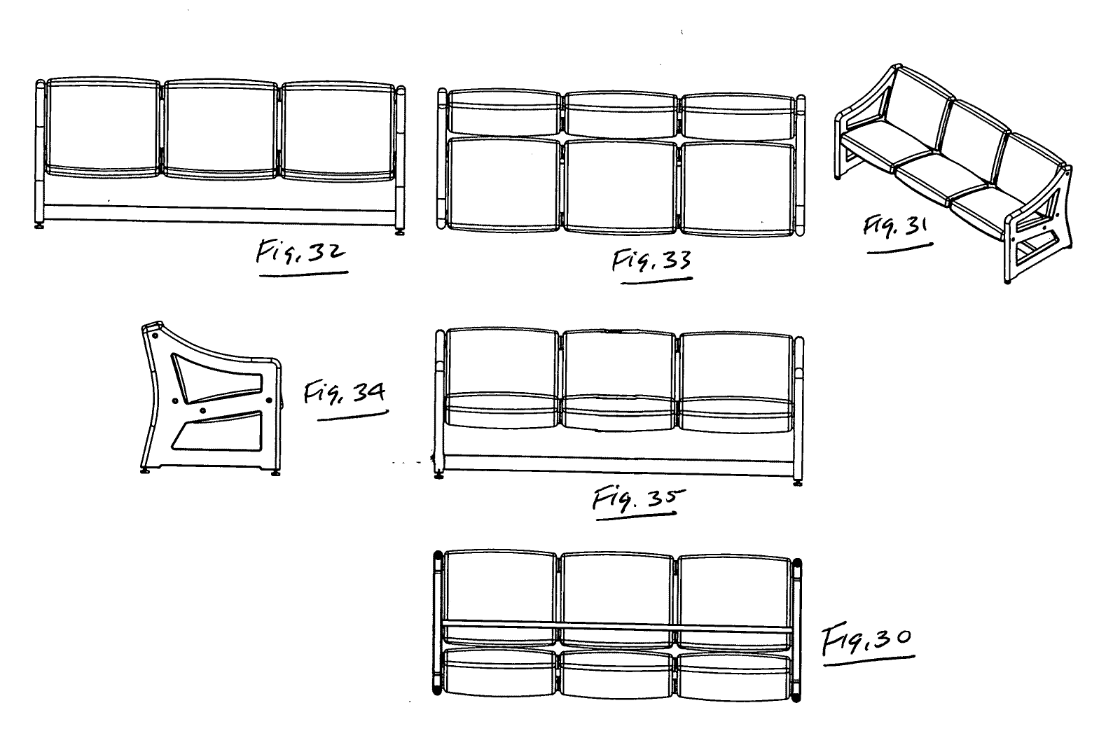

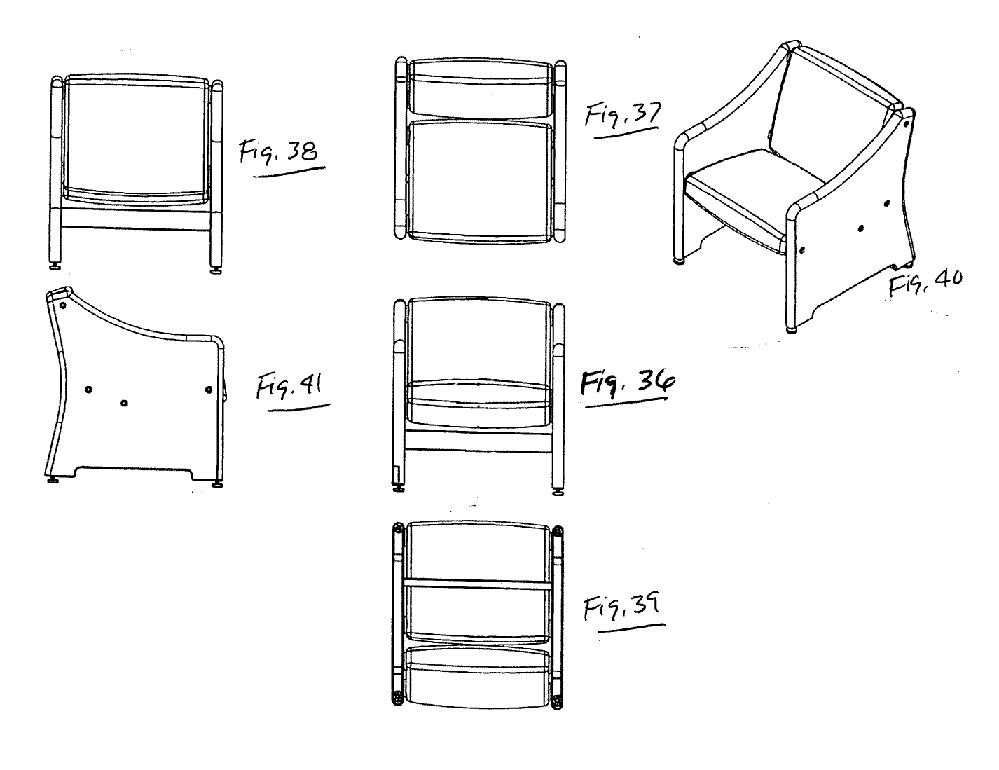

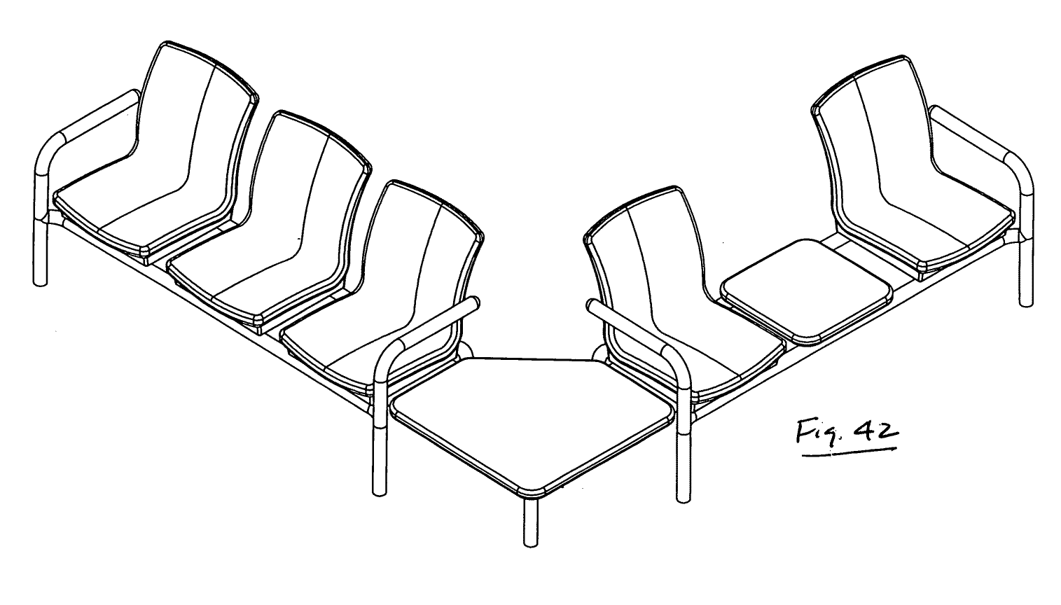

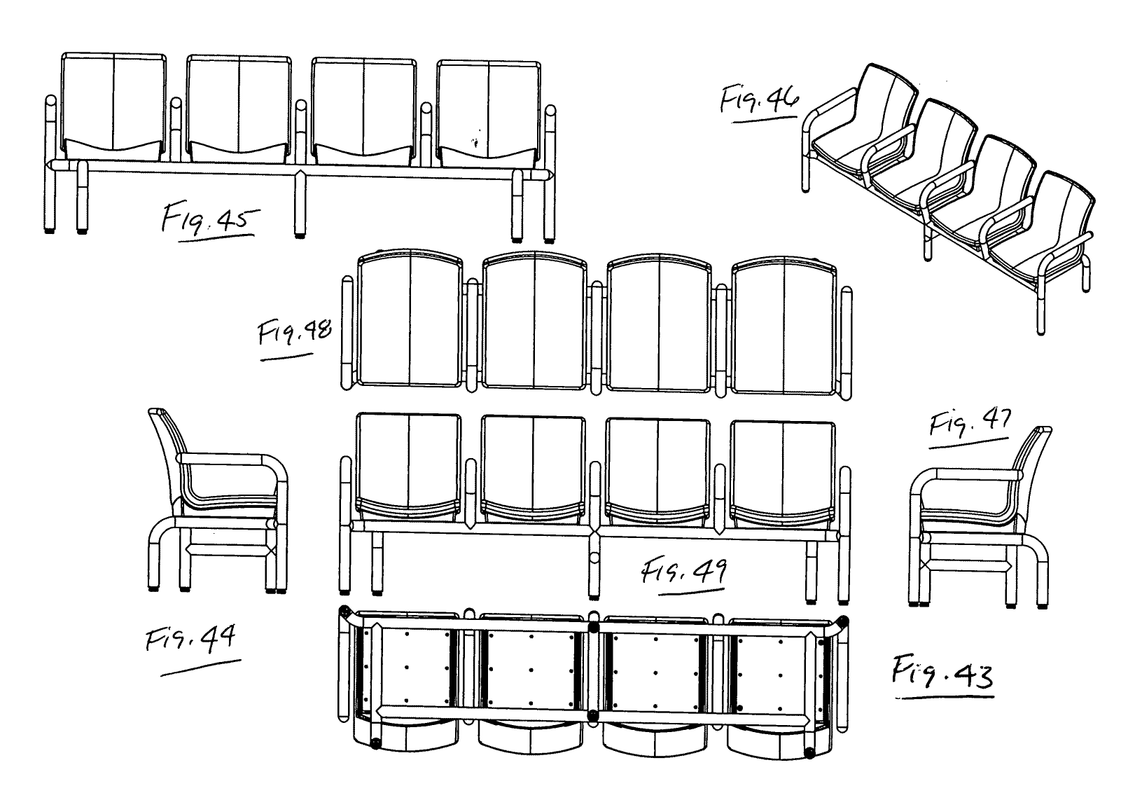

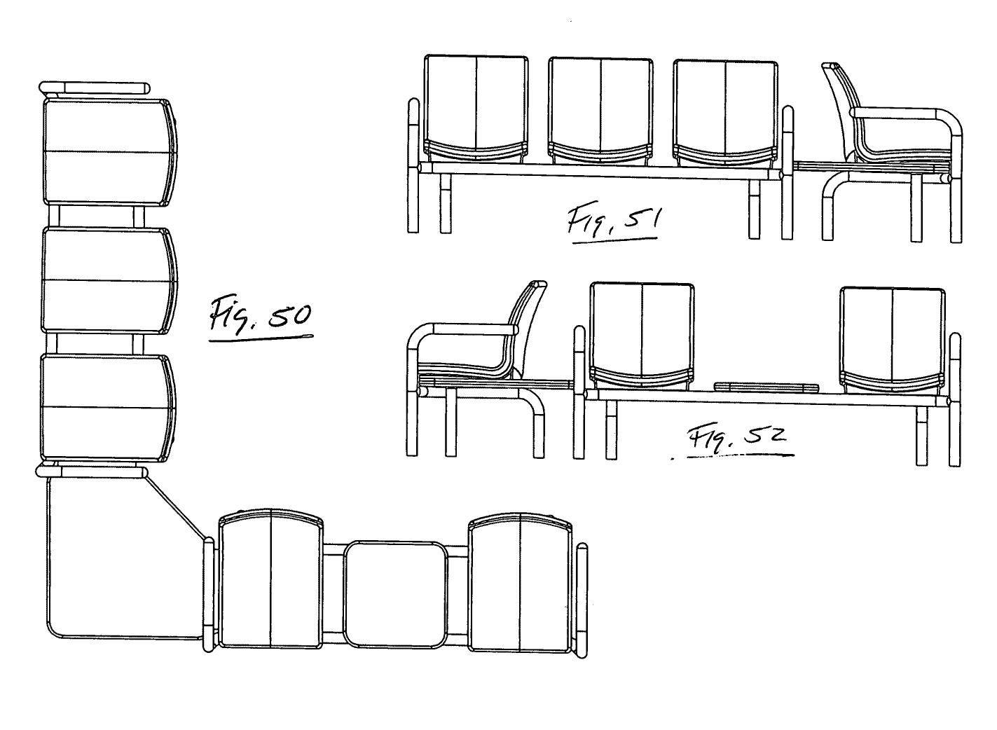

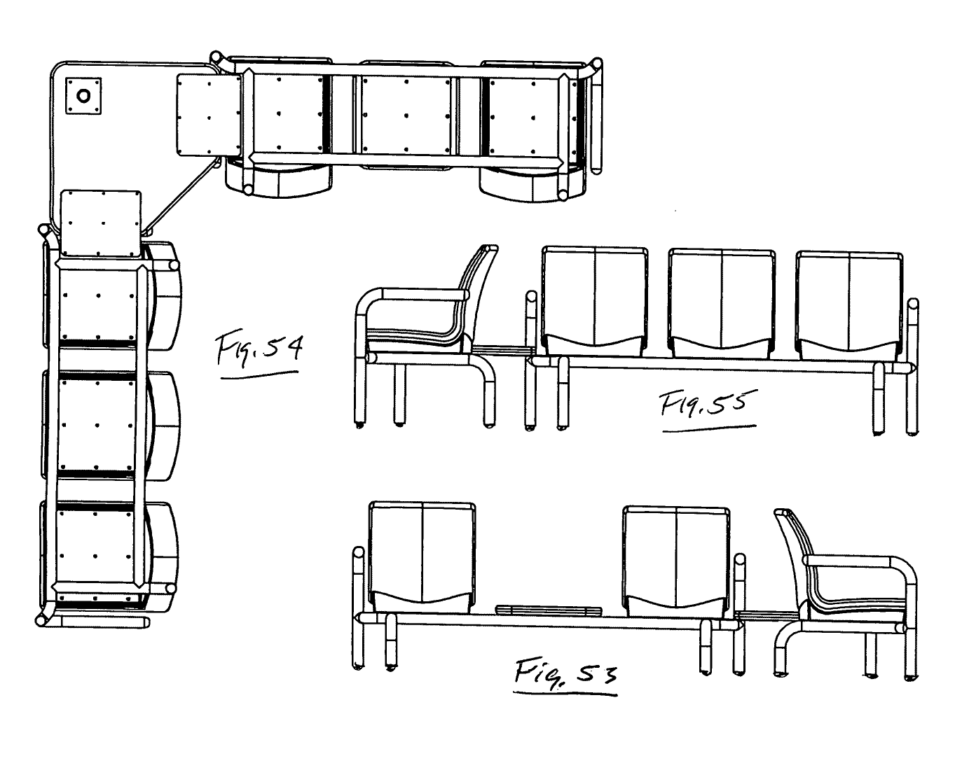

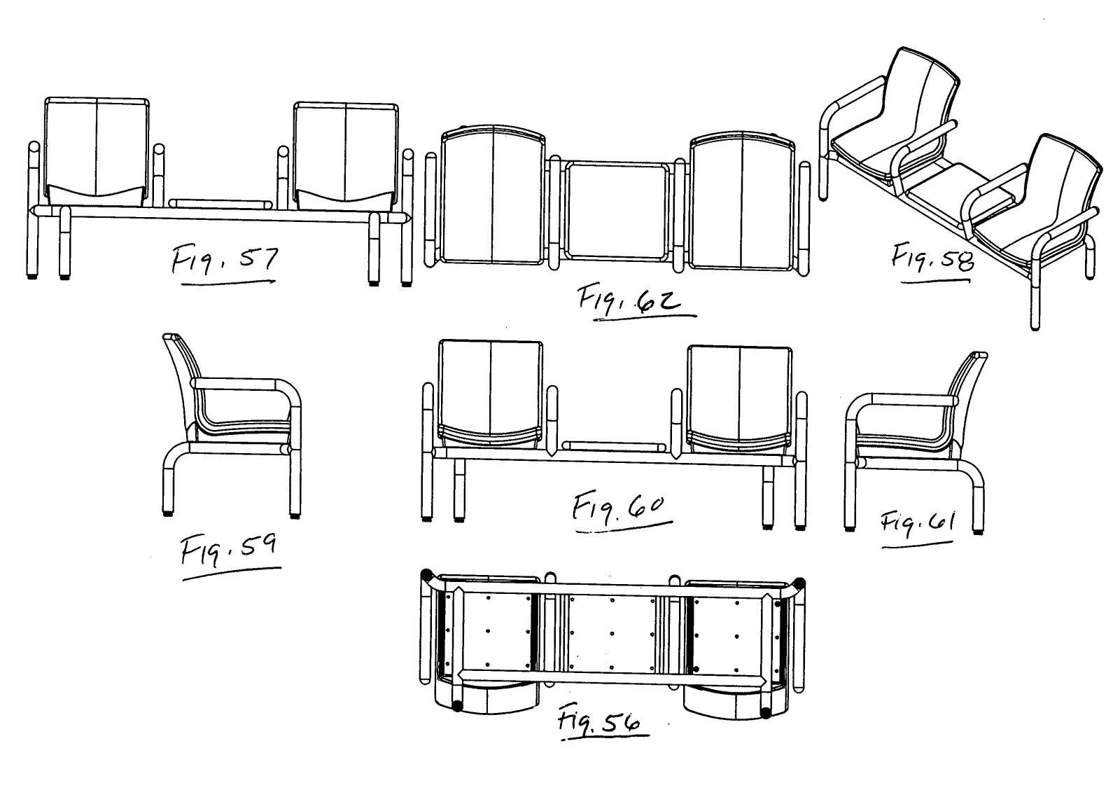

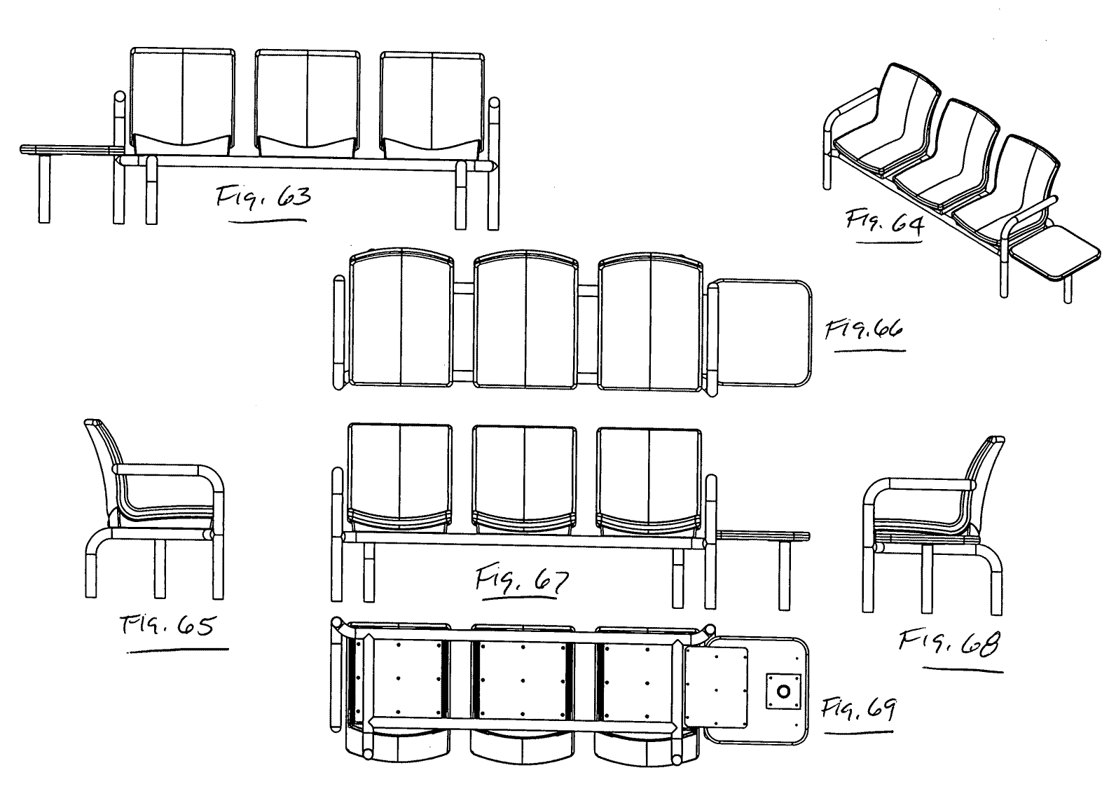

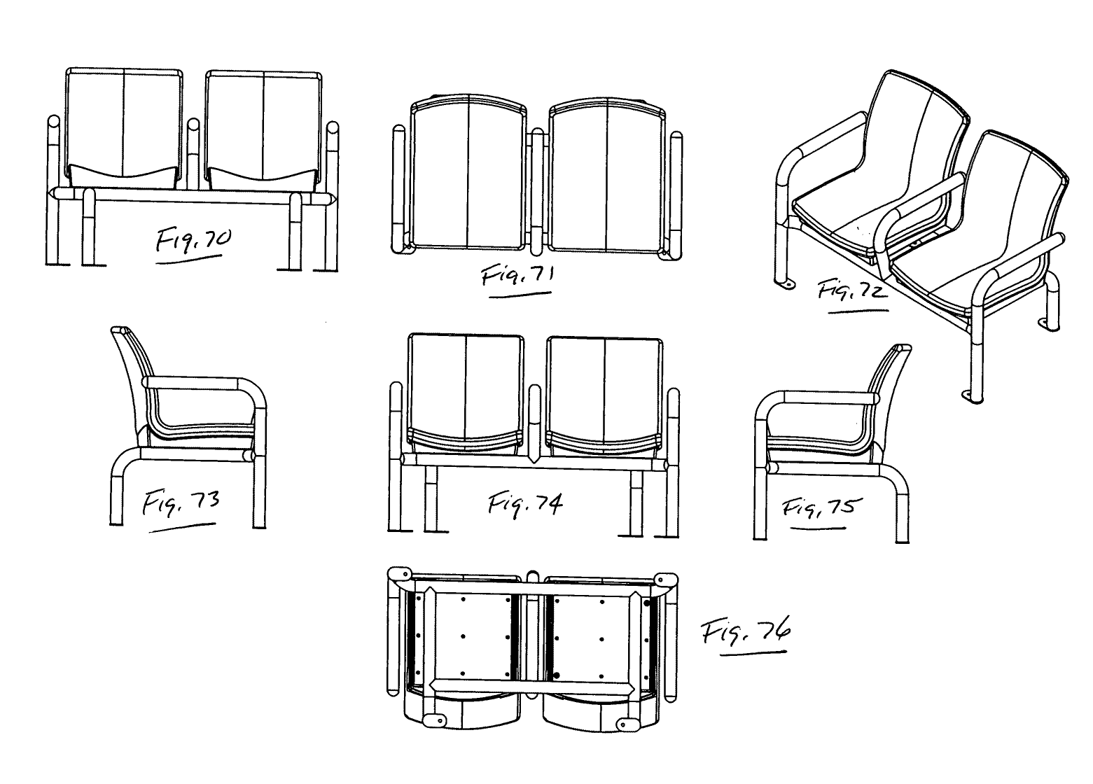

Referring to FIG. 2, glide assembly 10 may comprise a glide foot 52, a stem 54 an insert 56 and an insert retainer 57. The glide foot 52 comprises a top 60 having a stem mount 62 thereon and a bottom 64 having a floor-engaging pad 66. The stem mount 62 may comprise a pivotal joint 68 forming a rotational connection between the stem 54 and the glide foot 52 to rotate around the axis 110 of the stem 54 and may further be adapted to allow pivotal movement to orient the floor-engaging pad 66 at an angular relationship with to the stem 54.

Continuing to refer to FIG. 2, the stem 54 may have an elongate shape comprising a first end 69 adjacent to the glide foot 52 and a second end 70 extending from the glide foot 52. The stem 54 may further comprise a threaded portion 74 intermediate the first end 68 and the second end 70 and a hex adapter 72 may be connected adjacent the first end 68.

Continuing to refer to FIG. 2, insert retainer 57 may comprise a deformation of stem 54 adjacent second end 70 or an attachment such as a cap 58 having a top end 76 and a foot end 78. The cap 58 may have a generally cylindrical shape 80 with a central aperture 82 extending there through or may further comprise a distorted thread lock nut, a center lock nut, snap ring or other device to interfere with the removal of the insert 56 from the stem 54. The deformation on second end 70 may be stamped or coined to form a distorted cold head 71 to prevent removal of the insert 56.

Continuing to refer to FIG. 2, the insert 56 may have a generally elongate shape 84 having a cap end 86 and a glide foot end 88 and a body 89 having a contoured outside 90 adapted to attach in leg 120 (FIGS. 1, 5) by a means for fixation 92 on the outside 90. Means for fixation may be a contoured outside 90 having a coaxial depressed gripping regions 93 and projections 95 or pawls 96 (FIG. 5) extending in a generally radial direction from axis 110 (FIG. 5). Gripping regions 93 may comprise a central core 97 having a plurality of coaxial aligned projections 95 from insert body 89 forming shoulders 99 adjacent to valleys 97 configured to define a gripping region 93 for receiving molten plastic during integral molding or adding fixative 122 (FIG. 5) therebetween during assembly into the leg 120 (FIG. 5). During integral molding, plastic resin may flow into the space between landings to secure the insert in the leg 120. In addition, a fixative 122 (FIG. 5) such as a chemical adhesive may flow between the landings to secure the insert 56 in the leg 120. Outside 90 may have a non-circular cross sectional shape to prevent turning inside the leg 120. Insert 56 furthermore, may be mounted on stem 54 intermediate cap 58 and glide foot 52.

Referring to FIG. 3, insert retainer 57 may be an attachment on second end 70 such as cap 58. Cap 58 may be formed of plastic, metal, ceramic or other hard material. Cap 58 may have a generally cylindrical aperture 82 extending from the foot end 78. Cap 58 may further have inward oriented threads 94 formed in the aperture 82 for matingly adapting to the threaded portion 74 of stem 54. Adhesive 96 may be disposed on threaded interface between threaded portion 74 and cap threads 94 intermediate cap 58 and stem 54 to bond cap 58 to stem 54. Cap 58 may further have a thread distorting means 95 to prevent removal. In an alternate embodiment, a roll pin 111 (FIG. 5) may be inserted in an aperture 113 (FIG. 5) to prevent the insert 56 from unthreading from the stem 54.

Referring to FIG. 4, a second embodiment of the insert 56 may be threadably retained in furniture support 16 (FIG. 1). Body 89 of insert 56 may further comprise a flange 98 on glide foot end 88, a threaded portion 94 and cap end 86. Body 89 may be a single piece or may comprise a clamshell assembly disposed around stem 54. The flange 98 may be disposed at the bottom of the generally elongate shape 84. Outside 90 may have the means for fixation 92 comprising threads 94 or pawls 96 extending outward from the outside surface 90. The means for traversing along stem 100 may comprise a center passage 102 extending through the inert 56 from the glide foot end 88 to the cap end 86. Center passage 102 may have inner threads 104 formed therein for matingly engaging threaded portion 74 of stem 54. Threadably attaching the insert 56 to the stem 54 (FIG. 2) allows stem to traverse along threaded portion 74 upon rotation of stem 54, thereby moving the glide foot with respect to the insert 56.

Referring to FIG. 5, the floor-engaging portion 106 may be a leg 120, base or pedestal. Leg 120 may have a vertical passageway 108 extending from floor end 50 into leg 120. Insert 56 is mounted in leg 120 such that glide foot end 88 is spaced from floor end 50. Stem 54 is axially aligned with vertical passageway axis 110. Glide foot 52 may be intermediate floor end 50 and floor surface 112. Pad 66 is adjustably positioned with respect to leg 120 to engage floor surface 112 and support furniture such as chair 16 in a preferred position. Insert retainer 57 comprising cap 58 is attached to stem 54 at second end 70 using adhesive 96 or locking threads 94 or a combination.

Continuing to refer to FIG. 5, a counterbored opening 116 may be formed in floor end 50 to recess insert 56 in fixture 120. Flange 98 may be positioned against counterbore 116 to secure insert 56 in vertical passageway 108 spaced from floor end 50. Adapter threads 118 may be formed in vertical passageway 108 to threadably receive insert threads 94 in insert 56. The adapter threads 118 may be reverse handed from threads 74 on stem 54 to further prevent unthreading the insert 56. For example, the adapter threads 118 engaging insert threads 94 on the insert 56 may be right hand threads while threaded portion 74 of the stem 54 threadably engaging the inner threads 104 may together be formed with a left handed orientation. Fixative 122, such as an adhesive, may be used between the insert 58 and the leg 120 to further hold the insert in vertical passage 108 recessed from the floor end 50.

Referring to FIGS. 1-5 the method of providing a tamper resistant glide consists of the following steps, not necessarily in the order given:

On a furniture piece such as chair 16 supported by a leg 120 engaging the floor surface 112 to support the chair 16:

Form a generally vertical passageway 108 in leg 120;

Counterbore a recessed opening to the vertical passageway 108 in the floor surface for receiving the insert and forming adapter threads 118 in vertical passageway 108;

Provide a glide assembly 10 having foot 52 on the stem 54 with insert 56 captured on the stem 54;

Form threads on stem 54 intermediate a first end 69 and second end 70;

Provide insert 56 with an elongate body 89 having a center passage 102 formed there through, form threads 104 on center passageway 102,

Provide means to adjust position of insert on stem and holding means to hold insert at a predetermined position intermediate the first end 69 and second end 70 of stem 54;

Provide insert retainer 57 on second end adjacent insert 56;

Dispose glide assembly 10 in a generally vertical passageway 108 having glide foot 52 adjacent floor end 50 and insert in vertical passageway 108 such that insert 56 is recessed inward from the floor end 50; and

Secure insert 56 in furniture support 106 by fixative 122 or set screw 116 or other means for fixing so floor end 50 is disposed between insert 56 and the glide foot 52.

The method of forming a tamper resistant glide 10 may further comprise the steps of:

Forming the insert retainer 57 by attaching a cap 58 on the second end 70.

Threading cap 58 on the second end 70;

Disposing an adhesive 96 on the threaded interior 94 of the cap to fix cap 58 to stem 54 with adhesive 96 between threads 94 and stem 54;

Attaching the glide assembly 10 in the leg 120 by insert molding the stem 54 with insert 56 captured thereon into the leg 120;

The means for preventing tampering by tamper resistant glide 10 comprising a recessed insert 56 fixed in the furniture support 12. The first embodiment may further provide a means of preventing tampering of glide assembly 10 by capturing stem 54 in insert 56, recessed mounting insert 56 in the furniture support 12 having glide foot end 88 spaced from floor end 50, and attaching insert 56 in the furniture support 12 by contoured outside 90. Insert 56 may be fixed by insertion into vertical passageway 108 or integrally molding the insert 56, having stem 54, attached, into leg 120.

Means for preventing tampering may further comprise a reverse threaded vertical passage 108 formed in the furniture support 12 preventing the threaded passage 108, engaged to threads 94, from working with threaded passage 102, engaged to threaded portion 74, to remove insert 56. Insert 56 further may be recessed in the furniture support to prevent prying the insert 56 out by a tool (not shown) forced between the insert 56 and the furniture support 12. Means for preventing tampering may also comprise a means for locking the stem 54 in the insert 56 such as attaching foot 52 to the first end 69 and insert retainer 57 adjacent second end 70 having the insert 56 on the stem therebetween. Foot 52 and insert retainer adapted to interfere with the threading of the stem 54 out of the insert 56.

Although the description above contains many specifications, these should not be construed as limiting the scope of the invention but as merely providing illustrations of some of the embodiments of this invention. Thus, the scope of the invention should be determined by the appended claims and their legal equivalents rather than by the examples given.

What is claimed is:

1. A tamper resistant glide assembly mounted in a furniture support having a floor surface, the tamper resistant glide assembly comprising:
(A) a foot having a top and a bottom;
(B) a stem having a first end on the foot and a second end spaced from the foot;
(C) an insert retainer captured on the stem; and
(D) a means for attaching the insert in the furniture support having the floor surface intermediate the insert and the foot.

2. The tamper resistant glide of claim 1 further comprising a threaded portion on the stem intermediate the first end and the second end, the insert having a threaded interior passage extending there through, the threaded interior passage threadably engaged to the threaded portion.

3. The tamper resistant glide of claim 2 wherein the stem has a wrench engagement portion on the first end.

4. The tamper resistant glide of claim 1 wherein the insert retainer comprises a cap on the second end of the stem.

5. The tamper resistant glide of claim 4 wherein the cap is bonded to the second end of the stem.

6. The tamper resistant glide of claim 2 wherein the insert is threadably attached to the furniture support by reverse handed threads oriented opposite from the threaded portion of the stem.

7. The tamper resistant glide of claim 5 wherein the insert retainer further comprises a threaded passage in the cap engaging the threaded portion of the stem.

8. The tamper resistant glide of claim 1 wherein the insert further comprises a glide foot end adjacent the foot and a cap end intermediate the glide foot end and the second end, the furniture support adapted for receiving the insert such that the insert is recessed in the vertical passage.

9. The tamper resistant glide of claim 8 wherein the insert further comprises an exterior surface having outward oriented threads thereon, a vertical passage formed in the furniture support, the insert threadably engaging the vertical passage.

10. The tamper resistant glide of claim 9 further comprising a fixative in the vertical passage retaining the insert in place having the first end of the insert spaced from the floor surface.

11. A method of preventing tampering with a furniture glide assembly in a furniture support having a floor face comprising the steps, not all necessarily in the order shown, of:
(A) providing a foot having a stem thereon, the stem comprising a first end and a second end;
(B) capturing an insert on the stem, the insert having a means for threadably traversing along the stem intermediate the first and second end of the stem;
(C) mounting the insert having the stem attached in the furniture support recessed from the floor surface.

12. The method of claim 11 providing a threaded portion along the stem intermediate the first end and the second end, the insert further comprising an internally threaded passage matingly engaged to the threaded portion and fixing the insert in the furniture support.

13. The method of claim 11 wherein the step of mounting the insert further comprises the steps of:
(A) forming a vertical passage in the furniture support adapted for receiving the stem with the insert attached;
(B) inserting the insert in the vertical passage; and
(C) fixing the insert in the vertical passage to prevent removal.

14. The method of claim 11 wherein the step of capturing the insert further comprises the steps of further comprising the step of providing a cap having a threaded aperture threadably engaged to the second end.

15. The method of claim 14 further comprising the step of disposing an adhesive in the threaded aperture of the cap and the second end of the stem.

16. The method of claim 13 further comprising the step of disposing a fixative on an interior surface of the vertical passage for attaching the insert in the furniture support.

17. The method of claim 13 further comprising the step before inserting the insert in the vertical passage of counterboring the vertical passage in the floor surface for receiving the insert.

18. A tamper resistant glide assembly in a furniture leg comprising:
(A) a mounting means for mounting a the tamper resistant glide assembly comprising an foot having a stem attached, an insert captured on the stem and an insert retainer on the stem, the mounting means comprising the insert recessed into the furniture support; and
(B) means for preventing removal of the stem from the furniture support.

19. The tamper resistant glide of claim 18 wherein the means for preventing removal comprises
the insert having a body with an outside and an inside threaded passage, the inside threaded passage having right handed threads formed therein, threads on the outside having a left handed orientation;
a threaded portion of the stem threadably engaging the inside threaded passage;
a glide aperture formed in the leg sized to receive the glide assembly, the glide aperture adapted to threadably receive the outside of the insert for holding the insert recessed in the leg.
